(19) United States
(12) Patent Application Publication
(10) Pub. No.: US 2013/0242828 A1
(43) Pub. Date: Sep. 19, 2013

(54) OPTIMIZED WAKEUP FOR COMMUNICATION DEVICES

(71) Applicants: Debesh Kumar Sahu, Hyderabad (IN); Bhaskara V. Batchu, Ameenpur Village (IN); Subbarayudu Mutya, Hyderabad (IN); Venkata Siva Prasad Gude, Hyderabad (IN)

(72) Inventors: Debesh Kumar Sahu, Hyderabad (IN); Bhaskara V. Batchu, Ameenpur Village (IN); Subbarayudu Mutya, Hyderabad (IN); Venkata Siva Prasad Gude, Hyderabad (IN)

(73) Assignee: Qualcomm Incorporated, San Diego, CA (US)

(21) Appl. No.: 13/607,361

(22) Filed: Sep. 7, 2012

Related U.S. Application Data
(60) Provisional application No. 61/553,777, filed on Oct. 31, 2011.

(51) Int. Cl. H04W 52/02

(52) U.S. Cl. CPC H04W 52/0229
USPC 370/311

(57) ABSTRACT

Devices, systems, articles of manufacture, and methods for optimized wake-up are described. According to some embodiments, page messages are received at a page message receiving sub-slot. The page messages can be received by a communication device's communication interface, processes by a communication device's processor, and stored in a communication device's memory. Upon receiving page messages, a wake-up record is updated. A communication device can enter sleep mode based in part on reception of the page messages. Other aspects, embodiments, and features are also claimed and described.

### RELATED APPLICATION AND PRIORITY CLAIM

This application is related to and claims priority to U.S. Provisional Patent Application Ser. No. 61/553,777, filed Oct. 31, 2011, for “OPTIMIZED WAKEUP” which is incorporated herein by reference for all purposes and as if fully set forth below.

### TECHNICAL FIELD

The present disclosure relates generally to wireless communication systems. More specifically, the present disclosure relates to systems and methods for optimized wakeup enabling efficient operation of communication devices.

### BACKGROUND

Wireless communication systems are widely deployed to provide various types of communication content such as voice, video, data and so on. These systems may be multiple-access systems capable of supporting simultaneous communication of multiple mobile devices with one or more base stations.

Within wireless communications systems, base stations may periodically send page messages to mobile devices residing in wireless networks. Page messages may notify a mobile device of an incoming voice call or give channel assignments to a mobile device. To receive these page messages, the mobile device needs to wake-up from sleep mode. Current wake-up methods can be improved.

### SUMMARY OF SOME EXAMPLE EMBODIMENTS

Devices, systems, articles of manufacture, and methods for optimized wake-up are described. According to one embodiment, a method for optimized wake-up is disclosed. Page messages are received at a page message receiving sub-slot. A wake-up record is updated. Sleep mode is entered. Other aspects, embodiments, and features are also claimed and described.

A page message may be detected in a sub-slot with a sub-slot number. The wake-up record may be updated based on the sub-slot number of the sub-slot. The wake-up record may include a stored sub-slot number and a counter. The sub-slot number of the sub-slot may not match the stored sub-slot number. Updating the wake-up record based on the sub-slot number may include resetting the count to 0, and setting the sub-slot number as the stored sub-slot number. The page message receiving sub-slot may be reset to a first sub-slot.

Updating the wake-up record may include determining if a sub-slot number of the page message receiving sub-slot matches a stored sub-slot number, and if so incrementing a count. The method may also include determining whether the count is greater than or equal to a consecutive sub-slot threshold. If the count is greater than or equal to the consecutive sub-slot threshold, the method may include adjusting the page message receiving sub-slot to the stored sub-slot number. The consecutive sub-slot threshold may be adjustable.

The wake-up record may be for a first PN code, and a method may also include, moving from a first PN code to a second PN code, storing the wake-up record for the first PN code, and determining whether a wake-up record for the second PN code has been created. A wake-up record for the second PN code may have been created and the method may include using the wake-up record for the second PN code. A wake-up record for the second PN code may not have been created, and the method may include generating a wake-up record for the second PN code, setting a stored sub-slot number for the second PN code to a first sub-slot, initializing the page message receiving sub-slot to the first sub-slot, and initializing a count for the wake-up record for the second PN code to 0.

The method may be performed by a wireless communication device. The method may increase a sleep time of a wireless communication device. The method may reduce the awake time of one subscription in slotted mode. This can aid to reduce conflicts between dual subscriptions wake-up in dual SIM dual standby devices. The method may improve call performance in a wireless communication device. Call performance may include higher throughput, greater capacity, or improved reliability. The method may be performed by a wireless communication device in at least one of a wireless network and a roaming network.

The paging message may be received via a paging channel. The paging message may not be received via a quick paging channel.

According to another embodiment, a wireless device configured for optimized wake-up is described. The wireless device includes a processor and executable instructions stored in memory that is in electronic communication with the processor. The wireless device receives page messages at a page message receiving sub-slot. The wireless device also updates a wake-up record. The wireless device additionally enters sleep mode.

According to yet another embodiment, a computer-program product for optimized wake-up is described. The computer-program product includes a non-transitory computer-readable medium having instructions thereon. The computer-program product includes instructions for receiving page messages at a page message receiving sub-slot. The computer-program product also includes instructions for updating a wake-up record. The computer-program product further includes instructions for entering sleep mode.

According to still yet another embodiment, a wireless communication device configured to periodically wake up for wireless communications is described. The wireless communication device includes a communications interface configured to receive a wireless signal. The wireless communication device includes also a processor. The processor is operatively coupled to the communications interface and is configured to wake up the device if the processor detects a page message in the wireless signal at a pre-determined sub-slot number. The processor is also configured to update a wake-up record. The processor is further configured to return to sleep mode.

According to yet another embodiment, a wireless device configured for optimized wake-up is described. The apparatus includes means for receiving page messages at a page message receiving sub-slot. The apparatus also includes means for updating a wake-up record. The apparatus further includes means for entering sleep mode.

Other aspects, features, and embodiments of the present invention will become apparent to those of ordinary skill in the art, upon reviewing the following description of specific, exemplary embodiments of the present invention in conjunction with the accompanying figures. While features of the present invention may be discussed relative to certain embodiments and figures below, all embodiments of the present invention can include one or more of the advantageous features discussed herein. In other words, while one or more embodiments may be discussed as having certain advantageous features, one or more of such features may also be used in accordance with the various embodiments of the invention discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 shows an example of a wireless communication system in which embodiments of the present invention disclosed herein may be utilized;

FIG. 2 shows a block diagram of a transmitter and a receiver in a wireless communication system according to some embodiments of the present invention;

FIG. 3 shows a block diagram of a design of a receiver unit and demodulator at a receiver according to some embodiments of the present invention;

FIG. 4 shows a wireless communication system with multiple wireless devices in which embodiments of the present invention disclosed herein may be utilized;

FIG. 5 shows a timing diagram of the optimized wake-up mode of a wireless communication device according to some embodiments of the present invention;

FIG. 6 shows another timing diagram of the optimized wake-up mode of a wireless communication device according to some embodiments of the present invention;

FIG. 7 shows a flow diagram illustrating a method for optimizing wake-up according to some embodiments of the present invention;

FIG. 8 shows a flow diagram illustrating a method for optimized wake-up during a switch of pseudonoise (PN) codes according to some embodiments of the present invention; and

FIG. 9 shows certain components that may be included within a wireless communication device according to some embodiments of the present invention.

### DETAILED DESCRIPTION OF ALTERNATIVE & EXEMPLARY EMBODIMENTS

More and more people are using wireless communication devices, for example, mobile phones, not only for voice but also for data communications. CMDA2000 is one such standard used for providing voice, data, and signaling services to and from wireless communication devices. A CDMA network may implement a radio technology such as Universal Terrestrial Radio Access (UTRA), CDMA2000, etc. UTRA includes W-CDMA and Low Chip Rate (LCR) while CDMA2000 covers Interim Standard 2000 (IS-2000), IS-95, and IS-856 standards. A TDMA network may implement a radio technology such as Global System for Mobile Communications (GSM). An OFDMA network may implement a radio technology such as Evolved UTRA (E-UTRA), IEEE 802.11, IEEE 802.16, IEEE 802.20, Flash-OFDMA, etc. UTRA, E-UTRA and GSM are part of Universal Mobile Telecommunication System (UMTS). Long Term Evolution (LTE) is a release of UMTS that uses E-UTRA. UTRA, E-UTRA, GSM, UMTS and Long Term Evolution (LTE) are described in documents from an organization named “3rd Generation Partnership Project” (3GPP). CDMA2000 is described in documents from an organization named “3rd Generation Partnership Project 2” (3GPP2).

In CDMA2000, a paging channel is used to transmit page messages to wireless communication devices in standby mode (also called idle mode). During standby mode, a wireless communication device continuously consumes power to sustain the circuitry needed to monitor the signals transmitted from a base station. Continual monitoring of the paging channel for page messages in standby mode may significantly deplete battery power. In other words, elongating the time taken to monitor the paging channel results in excess power consumption. Because many wireless communication devices are portable and are powered by an internal battery, prolonging monitoring time unnecessarily consumes power and significantly shortens battery life. Depleted power resources can lead to poor user experience and also failed communications. Thus, reducing standby time on the wireless communication device will reduce power consumption and can aid in providing positive user experience.

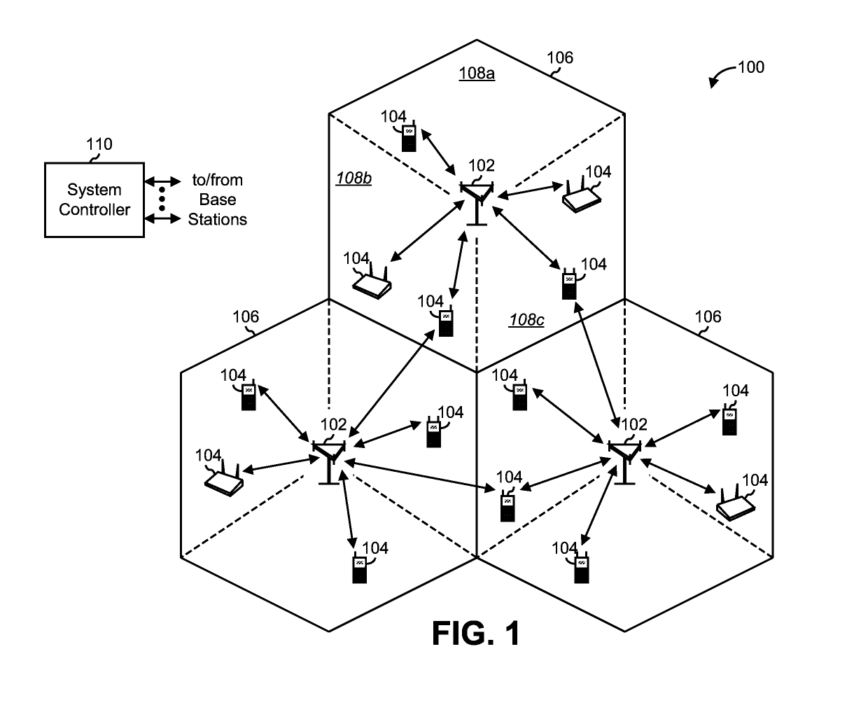

FIG. 1 shows an example of a wireless communication system 100 in which embodiments of the present invention disclosed herein may be utilized. The wireless communication system 100 includes multiple base stations 102 and multiple wireless communication devices 104. The wireless communication system 100 may be designed to implement one or more CDMA standards such as CDMA2000 and wideband code division multiple access (W-CDMA) and/or some other standards.

Each base station 102 provides communication coverage for a particular geographic area 106. The term “cell” can refer to a base station 102 and/or its coverage area 106 depending on the context in which the term is used. The terms “networks” and “systems,” as used herein, are sometimes used interchangeably.

The terms “wireless communication device” and “base station” utilized in this application can generally refer to an array of components. For example, as used herein, the term “wireless communication device” refers to an electronic device that may be used for voice and/or data communication over a wireless communication system. Examples of wireless communication devices 104 include cellular phones, smart phones, personal digital assistants (PDAs), handheld devices, wireless modems, laptop computers, personal computers, and many other portable or stationary devices capable of wireless communication. A wireless communication device 104 may alternatively be referred to as an access terminal, a mobile terminal, a mobile station, a remote station, a user terminal, a terminal, a subscriber unit, a subscriber station, a mobile device, a wireless device, user equipment (UE) or some other similar terminology. A wireless communication device may be used in a wireless network and/or a roaming network.

The term “base station” can refer to a wireless communication station that is installed at a fixed location and used to communicate with wireless communication devices 104. A base station 102 may alternatively be referred to as an access point (including nano-, pico- and femto-cells), a Node B, an evolved Node B, a Home Node B, or some other similar terminology. In some embodiments, base stations 102 may be mobile and can be repositioned as desired or needed for adequate network coverage.

To improve system capacity, a base station coverage area 106 may be partitioned into multiple smaller areas, e.g., three smaller areas 108a, 108b, and 108c. Each smaller area 108a, 108b, 108c may be served by a respective base transceiver station (BTS). The term “sector” can refer to a BTS and/or its coverage area 106 depending on the context in which the term is used. For a sectorized cell, the BTSs for all sectors of that cell are typically co-located within the base station 102 for the cell.

Wireless communication devices (e.g., subscriber stations) 104 are typically dispersed throughout the wireless communication system 100. A wireless communication device 104 may communicate with one or more base stations 102 on the downlink and/or uplink at any given moment. The downlink (or forward link) refers to the communication link from a base station 102 to a wireless communication device 104, and the uplink (or reverse link) refers to the communication link from a wireless communication device 104 to a base station 102. Uplink and downlink may refer to the communication link or to the carriers used for the communication link.

For a centralized architecture, a system controller 110 may couple to the base stations 102 and provide coordination and control for the base stations 102. The system controller 110 may be a single network entity or a collection of network entities. As another example, for a distributed architecture, base stations 102 may communicate with one another as needed. Thus embodiments of the present invention can be used with various network architectures although certain embodiments of the present invention may be discussed herein as relating to CDMA-type networks.

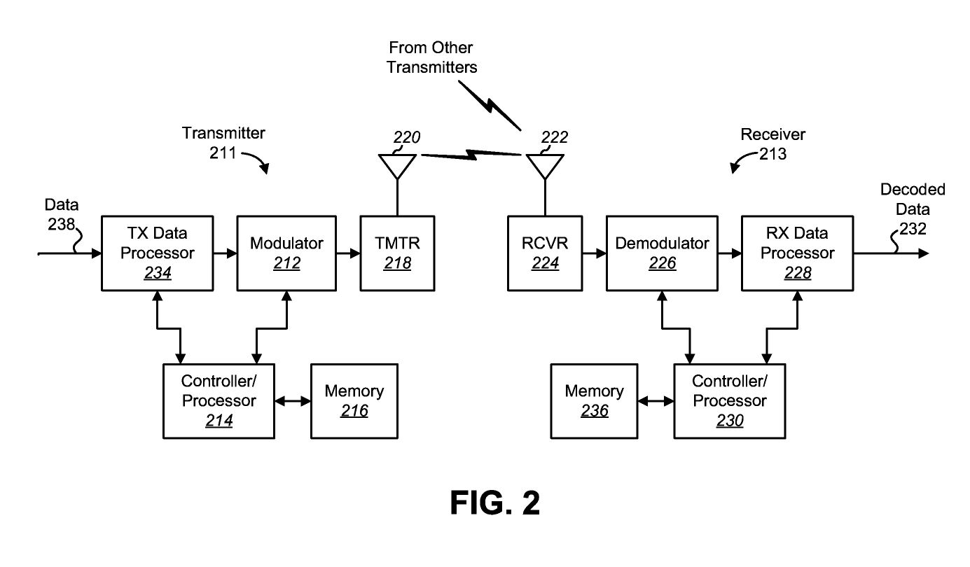

FIG. 2 shows a block diagram of a transmitter 211 and a receiver 213 in a wireless communication system 100 according to some embodiments of the present invention. For the downlink, the transmitter 211 may be part of a base station 102 and the receiver 213 may be part of a wireless communication device 104. For the uplink, the transmitter 211 may be part of a wireless communication device 104 and the receiver 213 may be part of a base station 102. In some embodiments, receivers and transmitters can be combined or implemented as a transceiver.

At the transmitter 211, a transmit (TX) data processor 234 receives and processes (e.g., formats, encodes, and interleaves) data 238 and provides coded data. The transmit (TX) data processor 234 may also receive page messages from a controller 214. A modulator 212 performs modulation on the coded data and provides a modulated signal. For IS-95 and CDMA2000 systems, the processing by modulator 212 may include covering coded and pilot data with Walsh codes to channelize user-specific data, messages, and pilot data onto their respective code channels and spreading the channelized data with a pseudorandom number (PN) sequence having a particular PN offset assigned to the base station. A transmitter unit (TMTR) 218 conditions (e.g., filters, amplifies, and upconverts) the modulated signal and generates an RF modulated signal, which is transmitted via an antenna 220.

At the receiver 213, an antenna 222 receives RF modulated signals from the transmitter 211 and other transmitters. The antenna 222 provides a received RF signal to a receiver unit (RCVR) 224. The receiver unit 224 conditions (e.g., filters, amplifies, and downconverts) the received RF signal, digitizes the conditioned signal, and provides samples. A demodulator 226 processes the samples as described below and provides demodulated data. For IS-95 and CDMA2000 systems, the processing by demodulator 226 includes despreading the data samples with the same PN sequence used to spread the data at the base station, decovering the despread samples to channelize the received data and messages onto their respective code channels and coherently demodulating the channelized data with a pilot recovered from the received signal. A receive (RX) data processor 228 processes (e.g., deinterleaves and decodes) the demodulated data and provides decoded data 232. In general, the processing by demodulator 226 and RX data processor 228 is complementary to the processing by the modulator 212 and the TX data processor 234, respectively, at the transmitter 211.

Controllers/processors 214 and 230 direct operation at the transmitter 211 and receiver 213, respectively. Memories 216 and 236 store program codes in the form of computer software and data used by the transmitter 211 and receiver 213, respectively.

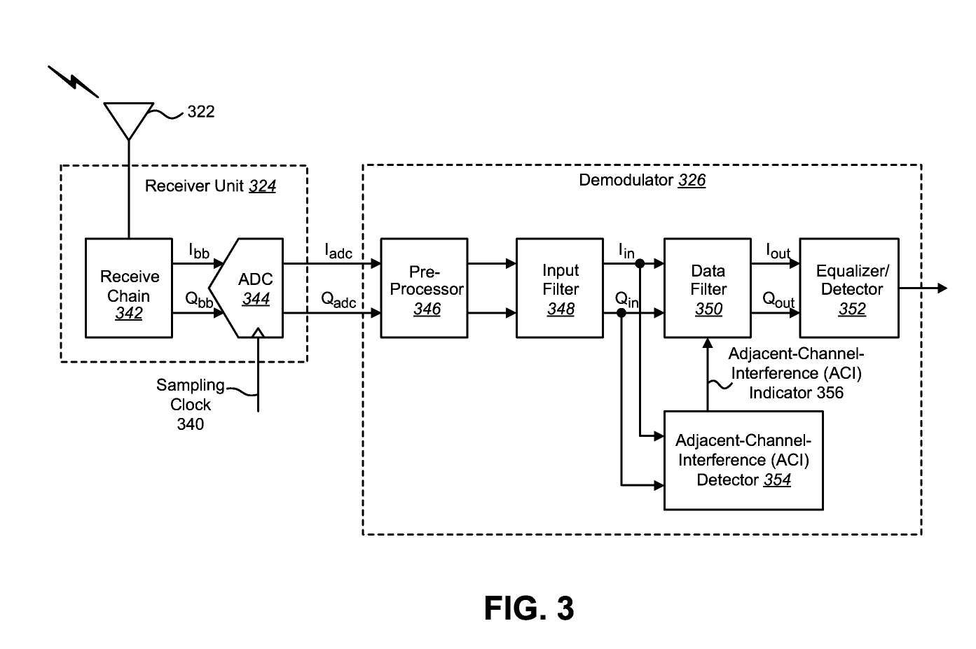

FIG. 3 shows a block diagram of a design of a receiver unit 324 and a demodulator 326 at a receiver 213 according to some embodiments of the present invention. Within the receiver unit 324, a receive chain 342 processes the received RF signal and provides I (inphase) and Q (quadrature) baseband signals, which are denoted as I_{bb} and Q_{bb}. The receive chain 342 may perform low noise amplification, analog filtering, quadrature downconversion, etc. as desired or needed. An analog-to-digital converter (ADC) 344 digitalizes the I and Q baseband signals at a sampling rate of f_{ad}, from a sampling clock 340 and provides I and Q samples, which are denoted as I_{adc} and Q_{adc}. In general, the ADC sampling rate f_{adc} may be related to the symbol rate f_{sym} by any integer or non-integer factor.

Within the demodulator 326, a pre-processor 346 performs pre-processing on the I and Q samples from the analog-to-digital converter (ADC) 344. For example, the pre-processor 346 may remove direct current (DC) offset, remove frequency offset, etc. An input filter 348 filters the samples from the pre-processor 346 based on a particular frequency response and provides input I and Q samples, which are denoted as Iᵢₙ and Qᵢₙ. The input filter 348 may filter the I and Q samples to suppress images resulting from the sampling by the analog-to-digital converter (ADC) 344 as well as jammers. The input filter 348 may also perform sample rate conversion, e.g., from 24× oversampling down to 2× oversampling. A data filter 350 filters the input I and Q samples from the input filter 348 based on another frequency response and provides output I and Q samples, which are denoted as Iₒᵤₜ and Qₒᵤₜ. The input filter 348 and the data filter 350 may be implemented with finite impulse response (FIR) filters, infinite impulse response (IIR) filters or filters of other types. The frequency responses of the input filter 348 and the data filter 350 may be selected to achieve good performance. In one design, the frequency response of the input filter 348 is fixed and the frequency response of the data filter 350 is configurable.

An adjacent-channel-interference (ACI) detector 354 receives the input I and Q samples from the input filter 348, detects for adjacent-channel-interference (ACI) in the received RF signal and provides an adjacent-channel-interference (ACI) indicator 356 to the data filter 350. The adjacent-channel-interference (ACI) indicator 356 may indicate whether or not adjacent-channel-interference (ACI) is present and, if present, whether the adjacent-channel-interference (ACI) is due to the higher RF channel centered at +200 kilohertz (kHz) and/or the lower RF channel centered at −200 kHz. The frequency response of the data filter 350 may be adjusted based on the adjacent-channel-interference (ACI) indicator 356, to achieve desirable performance.

An equalizer/detector 352 receives the output I and Q samples from the data filter 350 and performs equalization, matched filtering, detection and/or other processing on these samples. For example, the equalizer/detector 352 may implement a maximum likelihood sequence estimator (MLSE) that determines a sequence of symbols that is most likely to have been transmitted given a sequence of I and Q samples and a channel estimate.

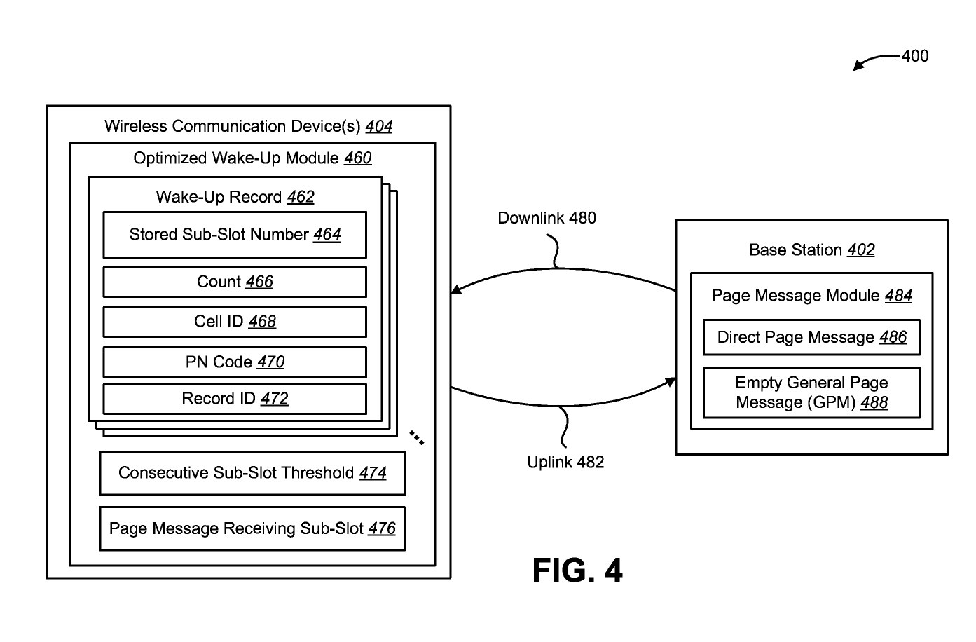

FIG. 4 shows a wireless communication system 400 with multiple wireless devices in which embodiments of the present invention disclosed herein may be utilized. The wireless communication system 400 of FIG. 4 may be one example of the wireless communication system 100 described above in connection with FIG. 1. For example, the base station 402 and wireless communication device 404 of FIG. 4 may correspond to the base station 102 and wireless communication device 104 of FIG. 1, respectively.

Communications in the wireless communications system 400 (e.g., a multiple-access system) may be achieved through transmissions over one or more wireless links, such as a downlink 480 or an uplink 482. The communication link may be established via a single-input and single-output (SISO), multiple-input and single-output (MISO) or a multiple-input and multiple-output (MIMO) system. A MIMO system includes transmitter(s) and receiver(s) equipped, respectively, with multiple (N_{T}) transmit antennas and multiple (N_{R}) receive antennas for data transmission. SISO and MISO systems are particular instances of a MIMO system. The MIMO system can provide improved performance (e.g., higher throughput, greater capacity or improved reliability) if the additional dimensionalities created by the multiple transmit and receive antennas are utilized.

A MIMO system may support both time division duplex (TDD) and frequency division duplex (FDD) systems. In a TDD system, downlink 480 and uplink 482 transmissions are on the same frequency region so that the reciprocity principle allows the estimation of the downlink channel from the uplink channel. This enables a transmitting wireless device to extract transmit beamforming gain from communications received by the transmitting wireless device.

The wireless communication system 400 may be a multiple-access system capable of supporting communication with multiple wireless communication devices 404 by sharing available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) Long Term Evolution (LTE) systems and spatial division multiple access (SDMA) systems.

A wireless communication device 404 may communicate with zero, one or multiple base stations 402 on the downlink 480 and/or uplink 482 at any given moment. As described above, the downlink 480 (or forward link) refers to the communication link from a base station 402 to a wireless communication device 404, and the uplink 482 (or reverse link) refers to the communication link from a wireless communication device 404 to a base station 402.

A wireless communication device 404 may operate in several modes or states, such as active mode, standby mode, and inactive mode. In active mode, the wireless communication device can actively exchange data with one or more base stations 402 (e.g., voice or data). In standby mode (i.e., idle mode), the wireless communication device 404 may monitor a paging channel for messages, such as general page messages (GPM) or direct messages addressed to the wireless communication device 404. In inactive or sleep mode, the wireless communication device 404 reduces power consumption by powering down as much circuitry as possible. In other words, in inactive or sleep mode, the wireless communication device 404 does not monitor the paging channel or perform access procedures.

The power consumption by the wireless communication device 404 in the standby mode decreases the available battery resources. This generally shortens the time between battery recharges. Power consumption in the standby mode is typically many times greater than that in the inactive mode. Any reduction in the amount of time spent in the standby mode may result in a direct and significant improvement in overall battery life of the wireless communication device 404. Therefore, it is desirable to minimize the wireless communication device's 404 power consumption in the standby mode to increase battery life. Power efficiency and conservation also becomes increasingly important as wireless communication devices become more feature rich.

In one configuration, to reduce power consumption in standby mode, messages on the paging channel may be sent to a wireless communication device 404 at designated times. For example, in CDMA2000 systems, the paging channel is divided into numbered “slots” (i.e., a slotted paging channel). Each slot may correlate to a slot cycle index (SCI).

The base stations 402 may assign one or more slots to the wireless communication device 404 to receive page messages. For example, under the IS-2000 standard, the paging channel is partitioned into two paging channel slots, each having an 80 millisecond (msec) duration. Each paging channel slot is further partitioned into four 20 msec frames or sub-slots. A group of wireless communication devices 404 may be assigned to each paging channel slot.

In a slotted paging channel, the wireless communication device 404 periodically, rather than continuously, monitors the paging channel for messages from the base station 402. In other words, the wireless communication device 404 may wake up at certain slots (corresponding to the slot cycle index (SCI) assigned to the wireless communication device) to decode page messages. The wireless communication device 404 wakes up from inactive mode prior to its assigned slot or sub-slot, switches into standby mode to detect the page message and enters active mode to processes the paging channel for messages. In other words, the wireless communication device 404 may wake-up at (e.g., just prior to) a pre-determined sub-slot number to process a page message received via wireless signals. The wireless communication device 404 may revert back to inactive mode if additional communication is not required. In this manner, power is conserved by reducing standby mode time.

In this configuration, the wireless communication device 404 will remain in the active or awake state if a received message requires the wireless communication device 404 to perform additional actions. When not in a standby or active state, the wireless communication device 404 reverts back to inactive mode. However, this configuration may be problematic because, if the base station 402 sends a page messages to the wireless communication device 404 while in inactive or sleep mode, the page messages will not be detected by the wireless communication device 404.

Additionally, under this configuration, if the base station 402 changes slots or sub-slots in which page messages are sent, the wireless communication device 404 may continuously miss page messages from the base station 402. Alternatively, if the base station 402 sends page messages in a different slot than currently assigned to the wireless communication device 404, the wireless communication device 404 may be awake until the page message is detected. In other words, the wireless communication device 404 will be unnecessarily awake for slots in which no page messages are being sent and power will be needlessly wasted.

In another configuration of a slotted paging channel, a wireless communication device 404 remains awake for the two 80 msec slots to detect page messages from the base station 402 or until a page message is received. The two slots may each be divided into four 20 msec sub-slots. In this configuration, the wireless communication device 404 may be required to remain awake for eight 20 msec (e.g., 160 msec).

In an optimal network, a base station 402 always sends the wireless communication device 404 a page message during the first sub-slot. This will allow the wireless communication device 404 to enter sleep mode shortly after the page message is received. In this way, the time spent in inactive mode is increased because the wireless communication device 404 will not be continuously searching for page messages in standby mode.

In a non-optimal network, the base station 402 may send the wireless communication device 404 a page message during a later sub-slot. A base station 402 may send a page message at a later sub-slot to ensure that all wireless communication devices 404 receive the page messages. However, this approach can be inefficient because it causes wireless communication devices 404 remain in standby mode for longer periods than necessary. Thus, when the base station 402 sends a page message to a wireless communication device 404 later than in the first sub-slot, the wireless communication device 404 will remain in standby mode for additional sub-slots for which no information is being received or decoded. For example, if the base station 402 sends the wireless communication device 404 a page message in the eighth sub-slot, the wireless communication device 404 may remain in standby mode unnecessarily for the first seven sub-slots (i.e., 140 msec).

In another configuration, a wireless communication device 404 may employ a quick paging channel (QPCH). A QPCH is a separate channel from the paging channel. The QPCH does not receive page messages, but rather is used to detect bits that inform the wireless communication device 404 whether to switch from inactive mode to standby mode to receive a page message on the paging channel.

The QPCH is used in conjunction with the paging channel and functions like a control channel for the paging channel. Each QPCH slot is associated with a corresponding paging channel slot, but is transmitted before the associated paging channel slot. For example, slot 2 of the QPCH slot is transmitted 100 milliseconds (msec) before slot 2 of the paging channel. A paging indicator bit, or bits, on the QPCH alerts the wireless communication device 404 that a coded page message is about to be transmitted on the paging channel in the associated paging channel slot. However, the QPCH may fail to receive or decode the paging indication bit(s). In this case, the page message sent to the paging channel will also fail to be received and decoded by the wireless communication device 404.

The QPCH may also send false alarms to the wireless communication device 404. In the case of a false alarm, the QPCH informs the wireless communication device 404 that a paging message is to be received in the next slot when no paging message is present. This causes the wireless communication device 404 to waste power by operating in standby mode when no page messages are being received.

As stated previously, the base station 402 may send a page message to the wireless communication device 404. The page message may be a direct page message 486 or a general page message. In some instances, the general page message (GPM) may be an empty general page message 488. Additionally or alternatively, the direct page message 486 may also be a general page message.

The base station 402 may include a page message module 484 that generates and sends a direct page message 486 and/or an empty general page message 488 to the wireless communication device 404. The wireless communication device 404 may also detect the direct page message 486 and/or the empty general page message 488. The wireless communication device 404 may also detect data for the next message that is not required for the page matching algorithm.

Direct page messages 486 may alert the wireless communication device 404 to the presence of incoming call system update parameters (e.g., overhead messages). If the wireless communication device 404 detects a direct page message 486, the wireless communication device 404 may perform access procedures.

An empty general page message (GPM) 488 may indicate that all the direct page messages 486 have been sent by the base station 402. If the wireless communication device 404 detects an empty general page message 488, the wireless communication device 404 may immediately go to sleep (e.g., inactive mode) instead of waiting for further page messages.

In one configuration in which embodiments of the present invention disclosed herein may be utilized, the wireless communication device 404 can include an optimized wake-up module 460. The optimized wake-up module 460 can help to increase sleep time. The optimized wake-up module 460 may allow the wireless communication device 404 to adjust the wake-up time of the wireless communication device 404 to a sub-slot later than the first sub-slot. In this manner, the wireless communication device 404 may enter standby mode in the same sub-slot as when the page message is being received. Thus, the amount of time the wireless communication device 404 is unnecessarily in standby mode is decreased.

Additionally, the optimized wake-up module 460 may reduce the standby time of one subscription in slotted mode. In this manner, the optimized wake-up module 460 may reduce the conflicts between dual subscriptions wakeup in Dual SIM Dual Standby (DSDS) devices (or any device containing multiple SIMs).

The optimized wake-up module 460 may include one or more wake-up records 462. Each wake-up record 462 may correspond to a stored sub-slot number 464, a count 466, a cell ID 468, a PN (pseudonoise) code 470 and/or a record ID 472. The number of wake-up records 462 on the optimized wake-up module 460 may depend on the number of cell IDs 468 and PN codes 470 available to the wireless communication device 404.

Only one wake-up record 462 may be active at a time. The active wake-up record 462 may correspond to the current cell ID 468 and current PN code 470 of the wireless communication device 404. Table 1 illustrates two wake-up records 462.

TABLE 1

| Record ID | Cell ID | PN Code | Stored Sub-Slot Number | Count |
|---|---|---|---|---|
| 0 | Cellid1 | PN1 | Sub-slot Number | Count1 |
| 1 | Cellid1 | PN2 | Sub-slot Number | Count2 |

The stored sub-slot number 464 may refer to the sub-slot or frame where a page message was recently decoded. In other words, the stored sub-slot number 464 may refer to the specific sub-slot for which the wireless communication device 404 was required to be in standby mode to detect and decode the page message. The base station 402 may assign and reassign the required sub-slot where the page message is to be received and decoded. Based on the sub-slot assignment by the base station 402, the wireless communication device 404 may change and/or update the stored sub-slot number 464. In other words, the new sub-slot number replaces the stored sub-slot number 464

In some instances, the wake-up record 462 may have only one stored sub-slot number 464. This may occur when the stored sub-slot number 464 is the sub-slot number for which the wake-up record 462 is currently counting. In other words, the base station 402 is sending page messages during the same sub-slot number as the stored sub-slot number 464. For example the base station 402 sends the page message during sub-slot 6 when the stored sub-slot number 464 is sub-slot 6.

When the wireless communication device 404 decodes a page message in a sub-slot, the count 466 is saved and/or incremented. If the wireless communication device 404 decodes a page message in a sub-slot that has the same sub-slot number as the stored sub-slot number 464, the count may be incremented. If the wireless communication device 404 decodes a page message in a sub-slot that has a different sub-slot number than the stored sub-slot number 464, the stored sub-slot number 464 may be set to the new sub-slot number and the count 466 may be reset (i.e., set to 0).

For example, if an empty general page message (GPM) 488 or a direct page message 486 is detected in the third sub-slot, the stored sub-slot number may be set to 3 and the count 466 may be set to 0. If the wireless communication device 404 subsequently (i.e., in the next slot corresponding to the slot cycle index (SCI) assigned to the wireless communication device 404) decodes another empty general page message 488 or a direct page message 486 in the third sub-slot, the stored sub-slot number may remain at 3 and the count may be incremented to 1. This process may be repeated as shown in Table 2 below. For example, the wireless communication device may receive two additional page messages, as shown in record ID 472 2 and 3 in Table 2.

TABLE 2

| Record ID | Cell ID | PN Code | Stored Sub-Slot Number | Count |
|---|---|---|---|---|
| 0 | Cellid1 | PN1 | Sub-slot 3 | 0 |
| 1 | Cellid1 | PN1 | Sub-slot 3 | 1 |
| 2 | Cellid1 | PN1 | Sub-slot 3 | 2 |
| 3 | Cellid1 | PN1 | Sub-slot 3 | 3 |
| 4 | Cellid1 | PN2 | Sub-slot 4 | 0 |

If the wireless communication device 404 subsequently decodes a page message in the fourth sub-slot, the stored sub-slot number 464 may be set to 4 and the count 466 may be reset to 0, as shown record ID 472 4 in Table 2. It should be noted that while multiple records are displaced for sub-slot 3 (e.g., record IDs 472 0-3), a single wake-up record 462 could be employed for sub-slot 3 where only the count 466 changes for each additional page message received at sub-slot 3. Under this latter approach, record ID 472 0 in Table 2 would correlate to sub-slot 3 and record ID 472 1 would correlate to sub-slot 4.

In some configurations, when the wireless communication device 404 subsequently decodes a page message in a sub-slot where it has previously counted, but is not currently counting, the count 466 may be either be reset to 0 or the count 466 may continue to be incremented. For example, in Table 2, if the wireless communication device 404 subsequently decodes a page messages in the third sub-slot, record ID 472 5 (not shown) may either reset to 0 or may be incremented to 4.

The wireless communication device 404 may also include a consecutive sub-slot threshold 474. The consecutive sub-slot threshold 474 may be a predefined threshold. In one configuration, the consecutive sub-slot threshold 474 may be configurable (e.g., adjustable or variable). For example, if the consecutive sub-slot threshold 474 is configurable, the base station 102 may change or update the consecutive sub-slot threshold 474 on the wireless communication device 404.

When the count is equal to or greater than the consecutive sub-slot threshold 474, the optimized wake-up module 460 may set a page message receiving sub-slot 476 to the stored sub-slot number 464. The page message receiving sub-slot 476 may indicate to the wireless communication device 404 which sub-slot the wireless communication device 404 should begin receiving page messages. Initially, the page message receiving sub-slot 476 may be set to the first sub-slot (e.g., the slot boundary). Whenever the count 466 is reset (e.g., set to 0), the page message receiving sub-slot 476 may also be reset to the first sub-slot. For example, if the page message receiving sub-slot 476 is set to the third sub-slot, the wireless communication device 404 may remain asleep during the first sub-slot and the second sub-slot, but wake up to receive page messages and perform page matching prior to the third sub-slot.

Using optimized wake-up may increase the sleep mode time of the wireless communication device 404. Depending, on the sub-slot in which the page message is transmitted, different increases in sleep mode duration may be achieved. Table 3 below shows the percentage of increase in sleep mode time based on the sub-slot number in which the page message is transmitted.

TABLE 3

| Sub-slot | Time in | Time in | Sleep Mode Time |
|---|---|---|---|
| Number in | Standby Mode | Standby Mode | Percentage of |
| which the | (if in | (if using | Increase (using |
| Page Message | Standby from | optimized | optimized |
| is Transmitted | sub-slot 1) | wake-up) | wake-up) |
| 2 | 40 ms | 20 ms | 100% |
| 3 | 60 ms | 20 ms | 200% |
| 4 | 80 ms | 20 ms | 300% |
| 5 | 100 ms | 20 ms | 400% |
| 6 | 120 ms | 20 ms | 500% |
| 7 | 140 ms | 20 ms | 600% |

Table 3 shows that the optimized wake-up module 460 can reduce the amount of standby time the wireless communication device 404 spends in standby mode monitoring for the page message. Optimized wake-up may be implemented with software changes in 1×Layer3 and 1×Layer1.

In addition, in low end chipsets, increases in sleep mode time may be very beneficial. For example, optimized wake-up may be useful in dual SIM dual standby (DSDS). A wireless communication device 404 that uses dual SIM dual standby (DSDS) may be any wireless communication device 404 that is capable of communicating using more than one radio access technology (RAT). For example, the optimized wake-up module 460 may reduce conflicts between CDMA and GSM wake-up.

Multiple SIM technology, such as Dual SIM dual standby (DSDS), is a popular feature in China, India, South East Asia, Latin America, and other markets. To be competitive in markets utilizing dual SIM dual standby (DSDS), a wireless communication device 404 may need to have optimal power consumption and lower hardware cost. For example, a wireless communication device 404 that has higher power consumption and a dual receiver may be unable to compete in a dual SIM dual standby (DSDS) market. Thus, reducing the hardware cost and power consumption of a dual SIM dual standby (DSDS) wireless communication device 404 is desirable.

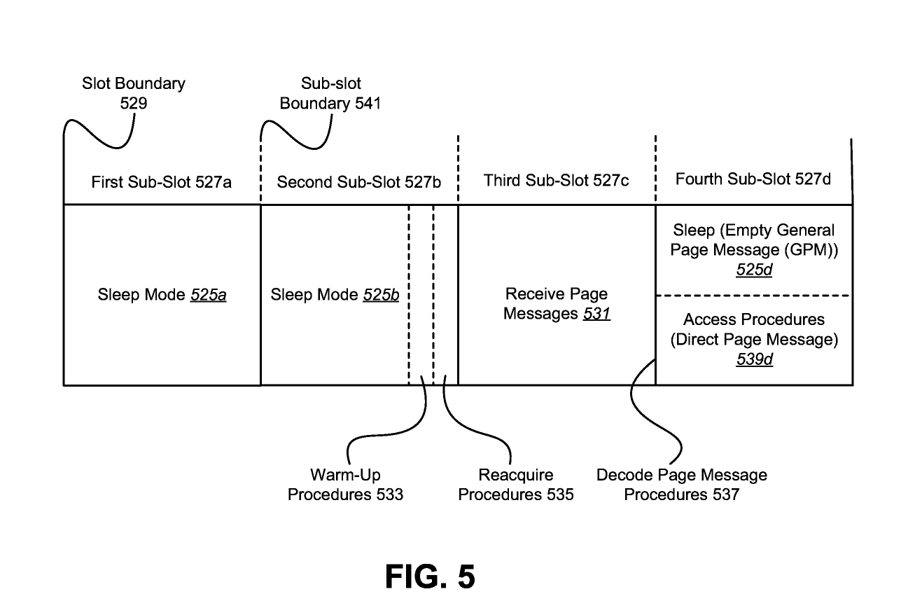

FIG. 5 shows a timing diagram of the optimized wake-up mode of a wireless communication device 104 according to some embodiments of the present invention. The timing diagram includes a slot of a paging channel separated into four sub-slots 527a-d or frames. The sub-slots 527a-d may be divided by sub-slot boundaries 541 with slot boundaries 529. For simplicity, only one slot boundary 529 and sub-slot boundary 541 is labeled. In some configurations, the sub-slots 527a-d may be 20 millisecond (msec) in duration and may combine to from one of the two 80 msec partitioned paging channel slots, as defined under the IS-2000 standard. Additionally, the sub-slot 527a-d may correlate to a slot cycle index (SCI).

In the timing diagram shown, the page message receiving sub-slot 476 may be set to sub-slot 3 (i.e., the third sub-slot 527c). When the page message receiving sub-slot 476 is set to sub-slot 3, the wireless communication device 104 does not wake-up (e.g., is in sleep mode 525a-b and does not enter standby mode) to receive page messages and perform page matching until just prior to the third sub-slot 527c. Thus, the wireless communication device 104 may remain in sleep mode 525 during the first sub-slot 527a and the second sub-slot 527b. Prior to the third sub-slot 527c, the wireless communication device 104 may wake-up in time to perform warm up procedures 533 and reacquire procedures 535. Reacquire procedures 535 may include synchronizing with the base station 102, aligning with the base station 102, determining which base station 102 is optimal, etc.

The wireless communication device 104 may receive 531 page messages during the third sub-slot 527c. It is assumed for this example that the base station 102 is sending the page message during the third sub-slot 527c. If the base station 102 does not send the page message in the third sub-slot 527c, the wireless communication device 104 may remain awake until either the page message is received 531 or the eighth sub-slot (not shown) is completed. If the page message is not included in any of the sub-slots subsequent to the third sub-slot 527c, the wireless communication device 104 may reset the page message receiving sub-slot 476 to the first sub-slot 527a, the stored sub-slot number 464 in the wake-up record 462 to the first sub-slot 527c and the count in the wake-up record 462 to 0. In this manner, the wake-up record 462 may be updated.

If the wireless communication device 104 receives 531 a page message in the third sub-slot 527c, the wireless communication device 104 may increment the count 466 in the wake-up record 462. The wireless communication device 104 may employ decode page message procedures 537. If the page message is an empty general page message (GPM) 488, the wireless communication device 104 may enter sleep mode 525d immediately (e.g., in the fourth sub-slot 527d). If the page message is a direct page message 486, the wireless communication device 104 may perform access procedures 539d.

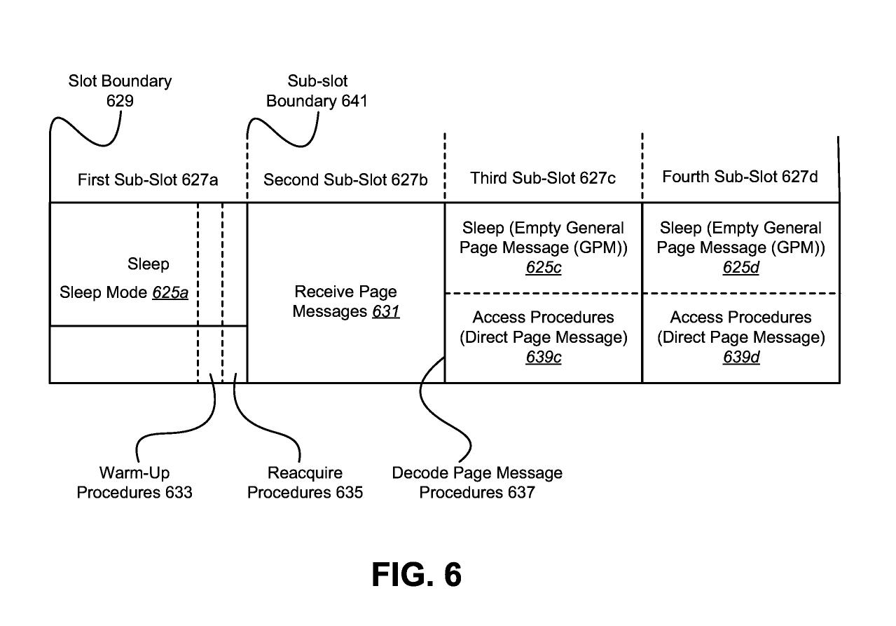

If the wireless communication device 104 subsequently receives a page message in the second sub-slot 527b, the wireless communication device 104 may reset the count 466 in the wake-up record 462. Additionally, the wireless communication device 104 may create a new wake-up record 462 indicating the stored sub-slot number 464 as the second sub-slot 527b rather that the third sub-slot 527c. This is shown in greater detail below in FIG. 6.

It should be noted that the timing diagram of FIG. 5 illustrates the timing for a page message received via the paging channel and not data or bits received on the quick paging channel (QPCH). The wireless communication device 104 described herein monitors the paging cannel, not the QPCH. In other words, the paging message is not received via a quick paging channel.

The embodiments of the present invention described herein may work with or without the presence of a QPCH. In the case of a QPCH, the QPCH may fail or miss a page indicator bit indicating a forthcoming paging message. In this case, the wireless communication device 104 will wake-up and monitor for a paging message based on the optimized wake-up module 460.

FIG. 6 shows another timing diagram of the optimized wake-up mode of a wireless communication device 104 according to some embodiments of the present invention. The timing diagram of FIG. 6 may include slot boundaries 629, sub-slot boundaries 641, sub-slots 627a-d, warm-up procedures 633, reacquire procedures 635 and decode page message procedures 637 similar to corresponding elements 529, 541, 527a-d, 533, 535 and 537 described above in connection with FIG. 5. The sub-slot 627a-d may correlate to a slot cycle index (SCI).

If the wireless communication device 104 subsequently receives a page message in the second sub-slot 527b, the wireless communication device 104 may reset the count 466 in the wake-up record 462. Additionally, the wireless communication device 104 may create a new wake-up record 462 indicating the stored sub-slot number 464 as the second sub-slot 527b rather that the third sub-slot 527c.

In the timing diagram shown, the page message receiving sub-slot 476 may be set to sub-slot 2 (i.e., the second sub-slot 627b) when a page message is received in the second sub-slot 627b. If the page message receiving sub-slot 476 was set to a sub-slot 627 other than the second sub-slot 627b, the wireless communication device 104 may change the page message receiving sub-slot 476 to the second sub-slot 627b.

However, in some instances, the wireless communication device 104 may not change the page message receiving sub-slot 476 to the second sub-slot 627b until the consecutive sub-slot threshold 474 has been met or exceeded. For example, the wireless communication device 104 may receive four subsequent page messages in the second sub-slot 627b, making the count 466 in the wake-up record 462 for that record ID 472 equal to 4. The wireless communication device 104 may then receive a single page message in the fourth sub-slot 627d. If the consecutive sub-slot threshold 474 is set to be greater than or equal to 3, the wireless communication device 104 may not change the page message receiving sub-slot 476.

Then if the wireless communication device 104 again receives a subsequent page message in the second sub-slot 627b, the count 466 for the original record may be incremented and the page message receiving sub-slot 476 may remain the second sub-slot 627b. In this manner, if the base station 102 sends a limited number of page messages in different sub-slots 627a-d, the wireless communication device 104 may still perform an optimized wake-up procedure when the base station 102 again sends page messages to the sub-slot 627a-d that correlates to the stored sub-slot number 464 in the wake-up record 462. Further, periodic page messages received at different sub-slots 627a-d due to errors, reflections, etc., will have a minimal effect on the optimized wake-up procedure.

Returning to FIG. 6, when the page message receiving sub-slot 476 is set to the second sub-slot 627b, the wireless communication device 104 does not wake-up (e.g., is in sleep mode 625a) to receive page messages and perform page matching until the second sub-slot 627b. Thus, the wireless communication device 104 may remain in sleep mode 625a during the first sub-slot 627a. Prior to the second sub-slot 627b, the wireless communication device 104 may wake-up in time to perform warm-up procedures 633 and reacquire procedures 635. This optimized wake-up procedure allows the wireless communication device 104 to remain in sleep mode 625 for a longer period of time.

The wireless communication device 104 may receive a page message 631 during the second sub-slot 627b. It is assumed for this example that the base station 102 is sending the page message during the second sub-slot 627b. If the wireless communication device 104 receives a page message 631 in the second sub-slot 627b, the wireless communication device 104 may increment the count 466 in the wake-up record 462. The wireless communication device 104 may also employ decode page message procedures 637. If the page message is an empty general page message (GPM) 488, the wireless communication device 104 may enter sleep mode 625c immediately (e.g., in the third sub-slot 627c) and continue in sleep mode 625d in the fourth sub-slot 627d.

If the page message is a direct page message 486, the wireless communication device 104 may perform access procedures 639c in the third sub-slot 627c and, if necessary, perform access procedures 639d in the fourth sub-slot 627d. If the wireless communication device 104 has completed the access procedures 639c in the third sub-slot 627c, the wireless communication device 104 may enter sleep mode 625d in the fourth sub-slot 627d. Overall, the optimized wake-up procedures as described in the embodiments of the present invention allow the wireless communication device 104 to remain in standby mode for less time, which leads to an increase in power savings.

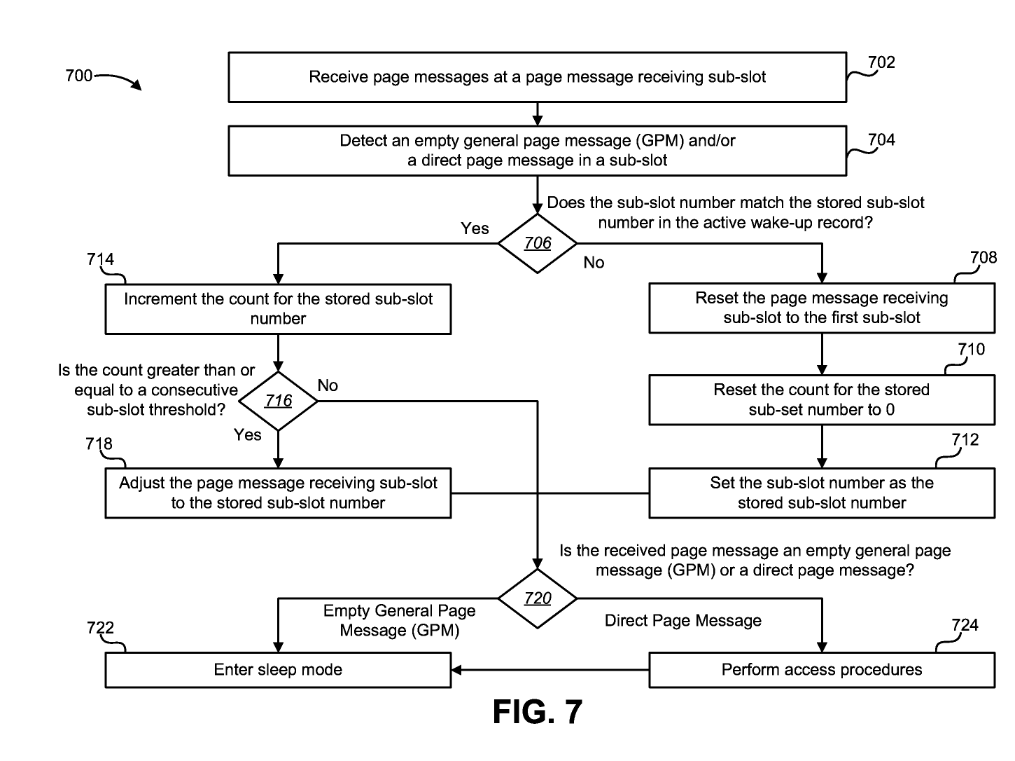

FIG. 7 shows a flow diagram illustrating a method 700 for optimizing wake-up according to some embodiments of the present invention. The method 700 may be performed by a wireless communication device 104. The wireless communication device 104 may receive 702 page messages at a page message receiving sub-slot 476. As discussed above, the page message receiving sub-slot 476 may be one of the sub-slots (e.g., sub-slots 527a-d) corresponding to the slot cycle index (SCI) assigned to the wireless communication device 104. The wireless communication device 104 may detect 704 an empty general page message (GPM) 488 and/or direct page message 486 in a sub-slot 527a-d.

The sub-slot 527a-d may correspond to a sub-slot number. For example, the second sub-slot 527b may correspond to sub-slot number 2. The wireless communication device 104 may then determine 706 whether the sub-slot number matches the stored sub-slot number 464 in the active wake-up record 462.

If the sub-slot number in which the page message was detected 704 is not the stored sub-slot number 464, the wireless communication device 104 may reset 708 the page message receiving sub-slot 476 to the first sub-slot (e.g., first sub-slot 527a). The wireless communication device 104 may also reset 710 the count 466 for the wake-up record 462 to 0. The wireless communication device 104 may set 712 the sub-slot number as the stored sub-slot number 464. Performing the steps of resetting 708 the page message, resetting 710 the count 466 and/or setting 712 the sub-slot number 464 may update the wake-up record 462.

The wireless communication device 104 may determine 720 if the received page message is an empty general page message (GPM) 488 or a direct page message 486. If the received page message is an empty general page message (GPM) 488, the wireless communication device 104 may enter 722 sleep mode. In this case, the wireless communication device 104 may enter sleep mode until the next sub-slot defined by the page message receiving sub-slot 476. The wireless communication device 104 may than begin the method 700 over again.

If the received page message is a direct page message 486, the wireless communication device 104 may perform 724 access procedures. Once access procedures have been performed 724, the wireless communication device 104 may enter 722 sleep mode. The wireless communication device 104 may than begin the method 700 over again.

If sub-slot number in which the page message was detected 704 is the stored sub-slot number 464, the wireless communication device 104 may increment 714 the count 466 for the wake-up record 462. In this manner, the wake-up record 462 is updated. The wireless communication device 104 may then determine 716 whether the count 466 is greater than or equal to a consecutive sub-slot threshold 474.

If the count 466 is greater than or equal to the consecutive sub-slot threshold 474, the wireless communication device 104 may adjust 718 the page message receiving sub-slot 476 to the stored sub-slot number 464, which updates the wake-up record 462. Based on the determination 720, the wireless communication device 104 either enters 722 sleep mode or performs 724 access procedures, as described above. The wireless communication device 104 may than begin the method 700 over again.

If the count 466 is not greater than or equal to the consecutive sub-slot threshold 474, the wireless communication device 104 may make no adjustments to the page message receiving sub-slot 476. The wireless communication device 104 may then determine 720 if the received page message is an empty general page message (GPM) 488 or a direct page message 486. Based on the determination 720, the wireless communication device 104 either enters 722 sleep mode or performs 724 access procedures, as described above. The wireless communication device 104 may than begin the method 700 over again.

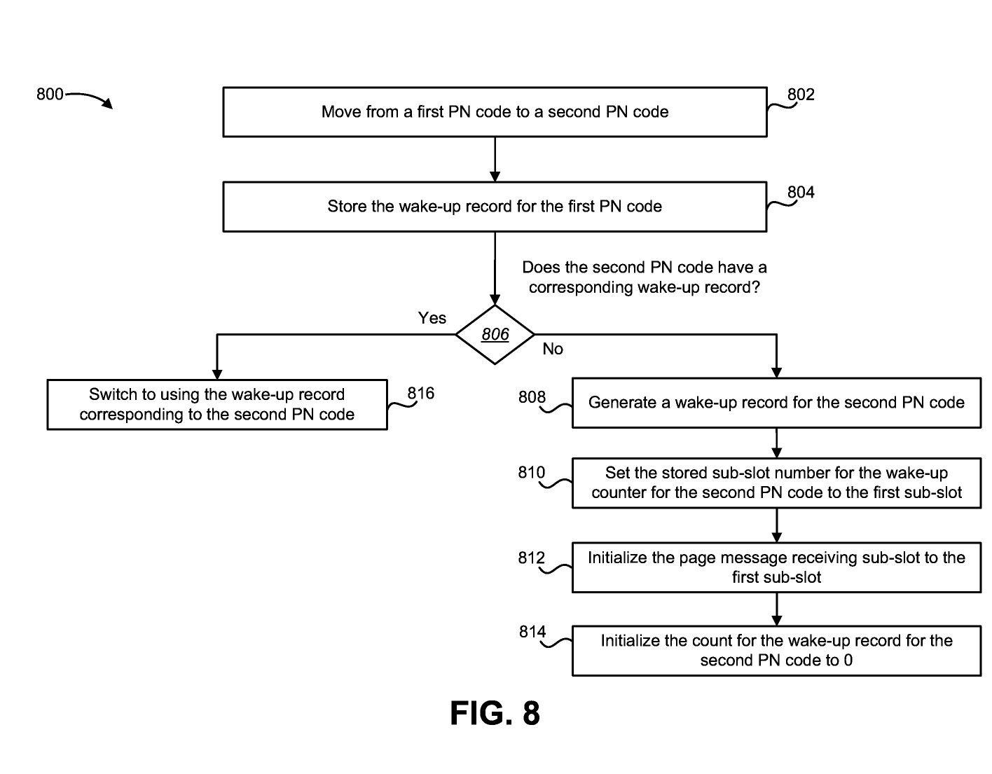

FIG. 8 shows a flow diagram illustrating a method 800 for optimized wake-up during a switch of pseudonoise (PN) codes 470 according to some embodiments of the present invention. The method 800 may be performed by a wireless communication device 104. The wireless communication device 104 may have an established wake-up record 462 for a first PN code. The wireless communication device 104 move 802 from the first PN code to a second PN code of the home system. The wireless communication device 104 may store 804 the wake-up record 462 for the first PN code. For example, the wake-up record 462 for the first PN code may be stored 804 for future use.

The wireless communication device 104 may determine 806 whether the second PN code has a corresponding wake-up record 462. In other words, the wireless communication device 104 may determine whether a wake-up record 462 for the second PN code is established. If a wake-up record 462 for the second PN code is established, the wireless communication device 104 may use 816 the wake-up record 462 for the second PN code. In this manner, the wireless communication device 104 may switch from the wake-up record 462 for the first PN code to the wake-up record 462 for the second PN code.

If a wake-up record 462 for the second PN code is not established, the wireless communication device 104 may generate 808 a new wake-up record 462 for the second PN code. The wireless communication device 104 may set 810 the stored sub-slot number 464 for the wake-up counter for the second PN code to the first sub-slot (e.g., first sub-slot 527a).

The wireless communication device 104 may initialize 812 the page message receiving sub-slot 476 to the first sub-slot (e.g., first sub-slot 527a). The wireless communication device 104 may initialize 814 the count 466 for the wake-up record 462 for the second PN code to 0.

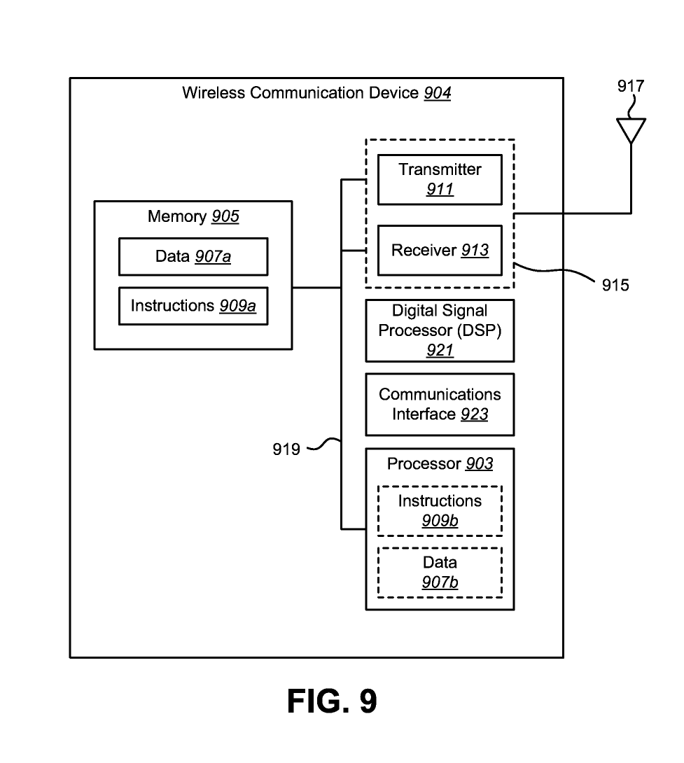

FIG. 9 shows certain components that may be included within a wireless communication device 904 according to some embodiments of the present invention. The wireless communication device 904 may be an access terminal, a mobile station, a user equipment (UE), etc. The wireless communication device 904 includes a processor 903. For example the wireless communication device 904 may be the wireless communication device 104 of FIG. 1 and/or the wireless communication device 404 of FIG. 4.

The processor 903 may be a general purpose single- or multi-chip microprocessor (e.g., an ARM), a special purpose microprocessor (e.g., a digital signal processor (DSP)), a microcontroller, a programmable gate array, etc. The processor 903 may be referred to as a central processing unit (CPU). Although just a single processor 903 is shown in the wireless communication device 904 of FIG. 9, in an alternative configuration, a combination of processors (e.g., an ARM and DSP) could be used.

The wireless communication device 904 also includes memory 905. The memory 905 may be any electronic component capable of storing electronic information. The memory 905 may be embodied as random access memory (RAM), read-only memory (ROM), magnetic disk storage media, optical storage media, flash memory devices in RAM, on-board memory included with the processor, EPROM memory, EEPROM memory, registers and so forth, including combinations thereof.

Data 907a and instructions 909a may be stored in the memory 905. The instructions 909a may be executable by the processor 903 to implement the methods disclosed herein. Executing the instructions 909a may involve the use of the data 907a that is stored in the memory 905. When the processor 903 executes the instructions 909, various portions of the instructions 909b may be loaded onto the processor 903, and various pieces of data 907b may be loaded onto the processor 903.

The wireless communication device 904 may also include a transmitter 911 and a receiver 913 to allow transmission and reception of signals to and from the wireless communication device 904 via an antenna 917. The transmitter 911 and receiver 913 may be collectively referred to as a transceiver 915. The wireless communication device 904 may also include (not shown) multiple transmitters, multiple antennas, multiple receivers and/or multiple transceivers.

The wireless communication device 904 may include a digital signal processor (DSP) 921. The wireless communication device 904 may also include a communications interface 923. The communications interface 923 may allow a user to interact with the wireless communication device 904.

The various components of the wireless communication device 904 may be coupled together by one or more buses, which may include a power bus, a control signal bus, a status signal bus, a data bus, etc. For the sake of clarity, the various buses are illustrated in FIG. 9 as a bus system 919.

The techniques described herein may be used for various communication systems, including communication systems that are based on an orthogonal multiplexing scheme. Examples of such communication systems include Orthogonal Frequency Division Multiple Access (OFDMA) systems, Single-Carrier Frequency Division Multiple Access (SC-FDMA) systems and so forth. An OFDMA system utilizes orthogonal frequency division multiplexing (OFDM), which is a modulation technique that partitions the overall system bandwidth into multiple orthogonal sub-carriers. These sub-carriers may also be called tones, bins, etc. With OFDM, each sub-carrier may be independently modulated with data. An SC-FDMA system may utilize interleaved FDMA (IFDMA) to transmit on sub-carriers that are distributed across the system bandwidth, localized FDMA (LFDMA) to transmit on a block of adjacent sub-carriers, or enhanced FDMA (EFDMA) to transmit on multiple blocks of adjacent sub-carriers. In general, modulation symbols are sent in the frequency domain with OFDM and in the time domain with SC-FDMA.

The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

The phrase “based on” does not mean “based only on,” unless expressly specified otherwise. In other words, the phrase “based on” describes both “based only on” and “based at least on.”

The term “processor” should be interpreted broadly to encompass a general purpose processor, a central processing unit (CPU), a microprocessor, a digital signal processor (DSP), a controller, a microcontroller, a state machine, and so forth. Under some circumstances, a “processor” may refer to an application specific integrated circuit (ASIC), a programmable logic device (PLD), a field programmable gate array (FPGA), etc. The term “processor” may refer to a combination of processing devices, e.g., a combination of a digital signal processor (DSP) and a microprocessor, a plurality of microprocessors, one or more microprocessors in conjunction with a digital signal processor (DSP) core, or any other such configuration.

The term “memory” should be interpreted broadly to encompass any electronic component capable of storing electronic information. The term memory may refer to various types of processor-readable media such as random access memory (RAM), read-only memory (ROM), non-volatile random access memory (NVRAM), programmable read-only memory (PROM), erasable programmable read-only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

The terms “instructions” and “code” should be interpreted broadly to include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can carry or store desired program code in the form of instructions or data structures and that can be accessed by a computer. Disk and disc, as used herein, includes compact disc (CD), laser disc, optical disc, digital versatile disc (DVD), floppy disk and Blu-Ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Further, it should be appreciated that modules and/or other appropriate means for performing the methods and techniques described herein, such as those illustrated by FIG. 7 and FIG. 8, can be downloaded and/or otherwise obtained by a device. For example, a device may be coupled to a server to facilitate the transfer of means for performing the methods described herein. Alternatively, various methods described herein can be provided via a storage means (e.g., random access memory (RAM), read-only memory (ROM), a physical storage medium such as a compact disc (CD) or floppy disk, etc.), such that a device may obtain the various methods upon coupling or providing the storage means to the device.

It is to be understood that the claims are not limited to the precise configuration and components illustrated above. Various modifications, changes and variations may be made in the arrangement, operation and details of the systems, methods, and apparatus described herein without departing from the scope of the claims.

We claim:

1. A method for optimized wake-up, comprising:
receiving page messages at a page message receiving sub-slot;
updating a wake-up record; and
entering sleep mode.

2. The method of claim 1, further comprising:
detecting a page message in a sub-slot with a sub-slot number; and
updating the wake-up record based on the sub-slot number of the sub-slot.

3. The method of claim 2, wherein the wake-up record comprises:
a stored sub-slot number; and
a counter.

4. The method of claim 3, wherein the sub-slot number of the sub-slot does not match the stored sub-slot number, and wherein updating the wake-up record based on the sub-slot number comprises:
resetting the count to 0; and
setting the sub-slot number as the stored sub-slot number.

5. The method of claim 4, further comprising resetting the page message receiving sub-slot to a first sub-slot.

6. The method of claim 1, wherein updating the wake-up record comprises determining if a sub-slot number of the page message receiving sub-slot matches a stored sub-slot number, and if so incrementing a count.

7. The method of claim 6, further comprising determining whether the count is greater than or equal to a consecutive sub-slot threshold.

8. The method of claim 7, wherein the count is greater than or equal to the consecutive sub-slot threshold, and further comprising adjusting the page message receiving sub-slot to the stored sub-slot number.

9. The method of claim 7, wherein the consecutive sub-slot threshold is adjustable.

10. The method of claim 1, wherein the wake-up record is for a first PN code, and further comprising:
moving from a first PN code to a second PN code;
storing the wake-up record for the first PN code; and
determining whether a wake-up record for the second PN code has been created.

11. The method of claim 10, wherein a wake-up record for the second PN code has been created, and further comprising using the wake-up record for the second PN code.

12. The method of claim 10, wherein a wake-up record for the second PN code has not been created, and further comprising:
generating a wake-up record for the second PN code;
setting a stored sub-slot number for the second PN code to a first sub-slot;
initializing the page message receiving sub-slot to the first sub-slot; and
initializing a count for the wake-up record for the second PN code to 0.

13. The method of claim 1, wherein the method is performed by a wireless communication device.

14. The method of claim 1, wherein the method increases a sleep time of a wireless communication device.

15. The method of claim 1, wherein the method reduces an awake time of one subscription in slotted mode, thereby reducing conflicts between dual subscriptions wake-up in dual SIM dual standby devices.

16. The method of claim 15, wherein the method improves call performance in a wireless communication device, wherein call performance comprises one of higher throughput, greater capacity, and improved reliability.

17. The method of claim 1, wherein the method is performed by a wireless communication device in at least one of a wireless network and a roaming network.

18. The method of claim 1, wherein the paging message is received via a paging channel.

19. The method of claim 1, wherein the paging message is not received via a quick paging channel.

20. A wireless device configured for optimized wake-up, comprising:
a processor;
memory in electronic communication with the processor;
instructions stored in the memory, the instructions being executable by the processor to:
receive page messages at a page message receiving sub-slot;
update a wake-up record; and
enter sleep mode.

21. The wireless device of claim 20, wherein the instructions are further executable to:
detect a page message in a sub-slot with a sub-slot number; and
update the wake-up record based on the sub-slot number of the sub-slot.

22. The wireless device of claim 21, wherein the wake-up record comprises:
a stored sub-slot number; and
a counter.

23. The wireless device of claim 22, wherein the sub-slot number of the sub-slot does not match the stored sub-slot number, and wherein updating the wake-up record based on the sub-slot number comprises:
resetting the count to 0; and
setting the sub-slot number as the stored sub-slot number.

24. The wireless device of claim 23, wherein the instructions are further executable to reset the page message receiving sub-slot to a first sub-slot.

25. The wireless device of claim 20, wherein updating the wake-up record comprises determining if a sub-slot number of the page message receiving sub-slot matches a stored sub-slot number, and if so incrementing a count.

26. The wireless device of claim 25, wherein the instructions are further executable to determine whether the count is greater than or equal to a consecutive sub-slot threshold.

27. The wireless device of claim 26, wherein the count is greater than or equal to the consecutive sub-slot threshold, and wherein the instructions are further executable to adjust the page message receiving sub-slot to the stored sub-slot number.

28. The wireless device of claim 26, wherein the consecutive sub-slot threshold is adjustable.

29. The wireless device of claim 20, wherein the wake-up record is for a first PN code, and wherein the instructions are further executable to:
move from a first PN code to a second PN code;
store the wake-up record for the first PN code; and
determine whether a wake-up record for the second PN code has been created.

30. The wireless device of claim 29, wherein a wake-up record for the second PN code has been created, and wherein the instructions are further executable to use the wake-up record for the second PN code.

31. The wireless device of claim 29, wherein a wake-up record for the second PN code has not been created, and wherein the instructions are further executable to:
generate a wake-up record for the second PN code;
set a stored sub-slot number for the second PN code to a first sub-slot;
initialize the page message receiving sub-slot to the first sub-slot; and
initialize a count for the wake-up record for the second PN code to 0.

32. The wireless device of claim 20, wherein the wireless device is a wireless communication device.

33. The wireless device of claim 20, wherein the wireless device has an increased sleep time.

34. The wireless device of claim 20, wherein the wireless device has a reduced awake time of one subscription in slotted mode, thereby reducing conflicts between dual subscriptions wake-up in dual SIM dual standby devices.

35. The wireless device of claim 34, wherein the wireless device has improved call performance, wherein call performance comprises one of higher throughput, greater capacity, and improved reliability.

36. The wireless device of claim 20, wherein the wireless device is in at least one of a wireless network and a roaming network.

37. The wireless device of claim 20, wherein the paging message is received via a paging channel.

38. The wireless device of claim 20, wherein the paging message is not received via a quick paging channel.

39. A computer-program product for optimized wake-up, the computer-program product comprising a non-transitory computer-readable medium having instructions thereon, the instructions comprising:
code for causing a wireless device to receive page messages at a page message receiving sub-slot;
code for causing the wireless device to update a wake-up record; and
code for causing the wireless device to enter sleep mode.

40. The computer-program product of claim 39, the instructions further comprising:
code for causing the wireless device to detect a page message in a sub-slot with a sub-slot number; and
code for causing the wireless device to update the wake-up record based on the sub-slot number of the sub-slot.

41. The computer-program product of claim 40, wherein the wake-up record comprises:
a stored sub-slot number; and
a counter.

42. The computer-program product of claim 39, wherein the code for causing the wireless device to update the wake-up record comprises code for causing the wireless device to determine if a sub-slot number of the page message receiving sub-slot matches a stored sub-slot number, and if so incrementing a count.

43. A wireless communication device configured to periodically wake up for wireless communications, the device comprising:
a communications interface configured to receive a wireless signal; and
a processor operatively coupled to the communications interface, configured to:
wake up the device if the processor detects a page message in the wireless signal at a pre-determined sub-slot number;
update a wake-up record; and
return to sleep mode.

44. The wireless communication device of claim 43, wherein the processor is further configured to:
detect a page message in a sub-slot with a sub-slot number at the pre-determined sub-slot; and
update the wake-up record based on the sub-slot number of the sub-slot.

45. The wireless communication device of claim 44, wherein the wake-up record comprises:
a stored sub-slot number; and
a counter.

46. The wireless communication device of claim 43, wherein updating the wake-up record comprises determining if a sub-slot number of the pre-determined sub-slot matches a stored sub-slot number, and if so incrementing a count.

47. A wireless device configured for optimized wake-up, comprising:
means for receiving page messages at a page message receiving sub-slot;
means for updating a wake-up record; and
means for entering sleep mode.

48. The wireless device of claim 47, further comprising:
means for detecting a page message in a sub-slot with a sub-slot number; and
means for updating the wake-up record based on the sub-slot number of the sub-slot.

49. The wireless device of claim 48, wherein the wake-up record comprises:
a stored sub-slot number; and
a counter.

50. The wireless device of claim 47, wherein the means for updating the wake-up record comprises means for determining if a sub-slot number of the page message receiving sub-slot matches a stored sub-slot number, and if so incrementing a count.
